(19) United States
(12) Patent Application Publication
(10) Pub. No.: US 2006/0072477 A1
(43) Pub. Date: Apr. 6, 2006

(54) Using configuration identifiers for communicating configuration descriptions

(75) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,847

(22) PCT Filed: Nov. 6, 2003
(86) PCT No.: PCT/IB03/05014

§ 371 Date: May 31, 2005

(30) Foreign Application Priority Data
Dec. 4, 2002 (EP) 020801338

(51) Int. Cl. H04L 12/28; H04L 12/00

(52) U.S. Cl. 370/254

(57) ABSTRACT

The present invention relates to a method, for a first communication device, of maintaining an up-to-date configuration description of a second communication device, said first device comprises a storage medium and is adapted for storing on said storage medium configuration descriptions being uniquely identified by a configuration identifier, the method comprises the steps of:—receiving from the second device information comprising a configuration identifier uniquely identifying the configuration of the second device,—checking whether the configuration description identified by the received configuration identifier is already stored on the storage medium,—if said configuration description is already stored on the storage medium, setting the configuration description corresponding to the received configuration identifier as the active configuration description of the second device,—if said configuration description identified by the configuration identifier is not stored on the storage medium, requesting and receiving the configuration description from said second device, storing said configuration description together with said configuration identifier on said storage medium and setting the configuration corresponding to the received configuration identifier as the active configuration description of the second device. The invention minimizes network load and can especially be advantageously used in UPnP networks.

The present invention relates to a method for a first communication device of maintaining an up-to-date configuration description of a second communication device. The invention further relates to an apparatus for maintaining an up-to-date configuration description of a second communication device. The invention also relates to a control point for maintaining an up-to-date configuration description of a second communication device.

Today a number of technologies exist, where a first device is adapted to use features of a second device either directly or indirectly. In this situation the first device needs to have information about the present configuration of the second device e.g. to ensure that the features of the second device are used optimally. Such technology is used in a number of applications such as standard computer networks either at home or within the industry or in situations, where a remote controller is used for controlling home appliances such as televisions, videos or industrial appliances.

“Universal Plug and Play (UPnP)” is architecture for pervasive peer-to-peer network connectivity of intelligent appliances, wireless devices, and PCs of all form factors. It is designed to bring easy-to-use, flexible, standard-based connectivity to ad-hoc or unmanaged networks whether in the home, in a small business, public spaces, or attached to the Internet. Universal Plug and Play is a distributed, open networking architecture that leverages TCP/IP and the Web technologies to enable seamless proximity networking in addition to control and data transfer among networked devices in the home, office, and public spaces. The UPnP standard is defined in the document “Universal Plug and Play Device Architecture”, Version 1.0, Jun. 8, 2000, (c) 1999-2000 Microsoft Corporation.

The UPnP 1.0 device architecture consists of six parts: addressing, discovery, description, control, eventing and presentation. In the present document it is the interaction between discovery and description that is being focused on.

The discovery process describes how devices that implement UPnP 1.0 control points can discover other devices that implement UPnP 1.0 controlled devices. Basically, a control point can listen to announcement messages from controlled devices. Controlled devices will periodically broadcast these announcements. Furthermore, control points can explicitly broadcast a request for announcements (a so-called M-SEARCH), if they do not want to wait for the periodic refresh. Controlled devices react to search requests by unicasting an announcement to the requesting control point. The discovery process also describes how control points can discover that specific controlled devices are no longer available. The UPnP 1.0 device architecture describes two mechanisms. First, devices can announce that they will no longer be available by sending a bye-bye message. However, there are circumstances in which a device cannot send a bye-bye message. For example, a device cannot send a bye-bye message in the event of sudden power loss or a sudden network disconnection. Secondly, to cover these events, all device announcements have a time-to-live. When the time-to-live expires, a control point can assume that the controlled device has left the network.

Once a control point has discovered a controlled device, it can proceed to retrieve the device and service descriptions. In general, the discovery process provides a control point with a rough idea of the capabilities of a controlled device (device type, provided services). The device and service descriptions explicitly and in detail describe the capabilities of the device (icon, friendly name, manufacturer, supported optional features, vendor extensions, allowed parameters, etc.). Due to their size and complexity, retrieving these descriptions poses quite a burden on the involved devices and the network. The UPnP 1.0 device architecture specifies that a control point can cache these descriptions as long as the corresponding discovery advertisements have not expired. This caching mechanism decreases the load on UPnP devices. However, if, due to a temporary disconnect of the network, advertisements time out, all control points will need to refresh their cache and download the descriptions. This places a peak load on an UPnP device, just after a time-out, or when the device first joins a network.

The UPnP 1.0 device architecture describes a two-step mechanism: discovery and description. While these two steps could be combined into a single step, having a two-step mechanism allows for effective caching of static information, which reduces the load on the network and the involved devices. The first step deals with the dynamics of the network: appearing, changing and disappearing devices. The second step provides a detailed view of the capabilities of the device, but is inherently less dynamic due to the size of the involved messages. However, the caching mechanism as described in the UPnP 1.0 architecture leads to peak loads after temporary network disconnections: cached information is invalidated by a time-out and needs to be refreshed.

In U.S. 2002/0027569 it is described how a user control point tool is used for allowing generic discovery, control, and display of Universal Plug and Play devices from a common user interface. This generic UCP tool provides a common user experience for all UPnP devices, regardless of their individual manufacturers. The generic UCP tool allows discovery of UPnP devices by type, by unique device name, or asynchronously. The user may select one of the discovered devices, view its properties, and select one of the services provided for that device to control. Additional information from a service description document may be viewed, and a user may query the value of the state variables and invoke an action for a service for the selected UPnP device. The results of the action are displayed on the tool's UI, as is the eventing information for the UPnP device. Status information for operation of the generic UCP tool itself is also provided. The document does not describe how to obtain UPnP device configuration for a control point.

It is therefore an object of the present invention to obtain a solution to the above mentioned problems.

This is obtained by a method for a first communication device of maintaining an up-to-date configuration description of a second communication device, said first device comprises a storage medium and is adapted for storing on said storage medium configuration descriptions being uniquely identified by a configuration identifier, the method comprises the steps of:

receiving from the second device information comprising a configuration identifier uniquely identifying the configuration of the second device,

checking whether the configuration description identified by the received configuration identifier is already stored on the storage medium,

if said configuration description is already stored on the storage medium, setting the configuration description corresponding to the received configuration identifier as the active configuration description of the second device,

if said configuration description identified by the configuration identifier is not stored on the storage medium, requesting and receiving the configuration description from said second device, storing said configuration description together with said configuration identifier on said storage medium and setting the configuration corresponding to the received configuration identifier as the active configuration description of the second device.

An advantage of this proposal is that it reduces peak loads on UPnP devices during start-up or network hiccups. Only if a control point receives an announcement of a device having an unknown configuration identifier, the configuration description is downloaded.

The invention further makes it possible for devices to “opt out’, and also allow devices to give different configuration identifiers to the same configuration. This last option can be useful, since the internal state of a device consists of more than the configuration information of the device and service description. This might make it difficult to detect that two internal configurations map to the same set of configuration descriptions.

Having configuration identifiers further allows e.g. a first device being a control point to maintain an extensive cache, not only for the current configuration descriptions, but also for past configuration descriptions, that could be reused in the future.

To minimize required standardization and simplify implementations, each controlled device can independently assign identifiers to its own configurations. For example, it can maintain a lookup table, have an internal state-transition-machine, or hash the set of description files. This allows caching per device. If cache size becomes a limiting factor, configuration numbers can be standardized for each device-type. This allows caching per device-type.

When applied to UPnP, the configuration identifiers could be included in ssdp:alive messages. If an UPnP device sends out two ssdp:alive messages with the same configuration number, this ensures that the device configuration is the same (same root device, embedded devices, services). This allows control points to (indefinitely) maintain a list of triplets: (device ID, configuration number, descriptions). Such an extended cache eliminates the need to download the same description twice.

Note that the present invention can be used in more advanced systems than in the UPnP 1.0 device architecture. UPnP 1.0 does not allow that a device changes its configuration while in operation. A device has to first leave the network (by sending bye-bye messages), and then reappear, announcing a new configuration. This can lead to inconsistent caches, for example when a control point misses the bye-bye messages, it can be unaware of the configuration change. Using the proposed configuration number, devices can change their configuration while continuing to offer services to the network without a full interruption. As an extension a “in transition” bit can be added to the discovery messages, which warns control points that a configuration change is about to happen.

A further advantage is that a control point, which is using a particular aspect of a device can continue to do so, if that aspect remains unchanged and it has already cached the new configuration.

A further advantage of configuration numbers is that a control point can include them in actions sent to a device. A device would refuse any actions that include the wrong configuration number. This eliminates racing conditions, where the control point bases its issued actions on a device configuration that has already changed.

In a specific embodiment the unique configuration identifier comprises an identification of the second device. When caching is based on (device ID, config. number)=>configuration, config. number need only be unique together with the deviceID. This simplifies assigning of unique configuration IDs.

In an embodiment the configuration description comprises an identification of the services offered by the second device. It is often the offered services that need to be known by the first device, e.g. when the first device is adapted for using services on the second device.

Thereby a single configuration number defines all present services in the device, removing the need for downloading their descriptions. Therefore, a single configuration number can be used for effective caching of a number of description files (of devices, embedded devices and services).

In an embodiment the configuration identifier is a device specific configuration number uniquely identifying the configuration of the device. A number as identifier can be represented by relatively few bits, whereby a very low bandwidth is needed to communicate the identifier, reducing the load on the network.

In an embodiment the configuration descriptions on the storage medium, which have not been accessed for the longest time interval, are deleted from the storage medium. Thereby a limited sized storage medium can be used decreasing the chance of running out of memory.

In an embodiment the second device generates the configuration identifier by deriving it from the configuration description using fingerprinting. Thereby configuration description specific configuration identifiers can easily be obtained. Fingerprinting could be performed by performing hashing on the configuration description; an example of such a hashing technique is MD5. Some of the existing fingerprinting techniques have a small chance of gene-rating the same configuration identifiers for two different configuration descriptions. In this case, the technique could be combined with a history check, whereby the second device checks the generated configuration identifier with previously used identifiers to ensure that it has not been used before for another configuration description. There are alternative ways of obtaining configuration specific configuration identifiers. These could e.g. be to have a predefined look-up table uniquely linking the possible configuration identifiers with configuration descriptions. Another way could be to have a configuration identifier being a number, which is incremented each time a new configuration description is defined. Incrementing configuration identifiers makes caching of old configurations impossible, since even if the second device reverts to an old configuration, it will give it a new configuration number that is unknown to the first device.

In a specific embodiment the first device is a control point in a UPnP network, and the second device is a UPnP device being part of the UPnP network. Especially in UPnP networks, the advantages of the present invention as described above are significant. Description information in UPnP is typically retrieved using a set of HTTP requests, separate calls for root device, embedded devices and their services and separate calls for “getcapability( )” like functions that are often defined in services. The presence of a configuration number that signifies that all these calls are cached eliminates the need for these calls.

The invention also relates to an apparatus for maintaining an up-to-date configuration description of a second communication device, said apparatus comprises a storage medium and is adapted for storing on said storage medium configuration descriptions being uniquely identified by a configuration identifier, the apparatus comprises:

means for receiving, from the second device, information comprising a configuration identifier uniquely identifying the configuration of the second device, means for checking whether the configuration description identified by the received configuration identifier is already stored on the storage medium,

means for, if said configuration description identified by the configuration identifier is stored on the storage medium, setting the configuration description corresponding to the received configuration identifier as the active configuration description of the second device,

means for, if said configuration description identified by the configuration identifier is not stored on the storage medium, requesting and receiving the configuration description from said second device, storing said configuration description together with said configuration identifier on said storage medium and setting the configuration corresponding to the received configuration identifier as the active configuration description of the second device.

The invention also relates to an UPnP control point for maintaining an up-to-date configuration description of a UPnP device, said control point comprises a storage medium and is adapted for storing on said storage medium configuration descriptions being uniquely identified by a configuration identifier, the control point comprises:

means for receiving from the second device information comprising a configuration identifier uniquely identifying the configuration of the UPnP device,

means for checking whether the configuration description identified by the received configuration identifier is already stored on the storage medium,

means for, if said configuration description identified by the configuration identifier is stored on the storage medium, setting the configuration description corresponding to the received configuration identifier as the active configuration description of the UPnP device,

means for, if said configuration description identified by the configuration identifier is not stored on the storage medium, requesting and receiving the configuration description from said UPnP device, storing said configuration description together with said configuration identifier on said storage medium and setting the configuration corresponding to the received configuration identifier as the active configuration description of the UPnP device.

In the following preferred embodiments of the invention will be described referring to the figures, where

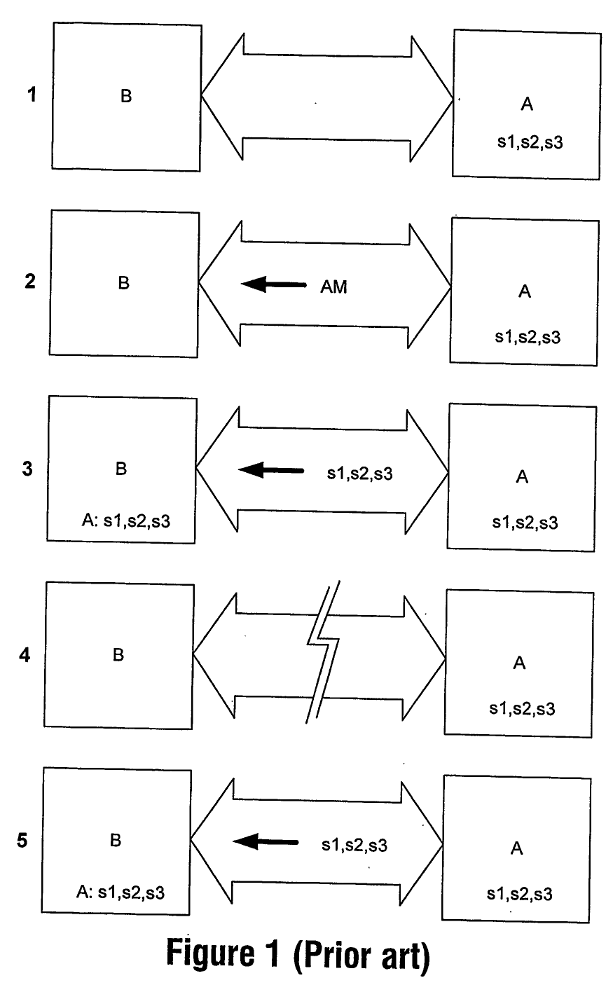

FIG. 1 is an illustration according to prior art of the method for a first communication device of maintaining an up-to-date configuration description of a second communication device, when the network connection between the two devices is interrupted,

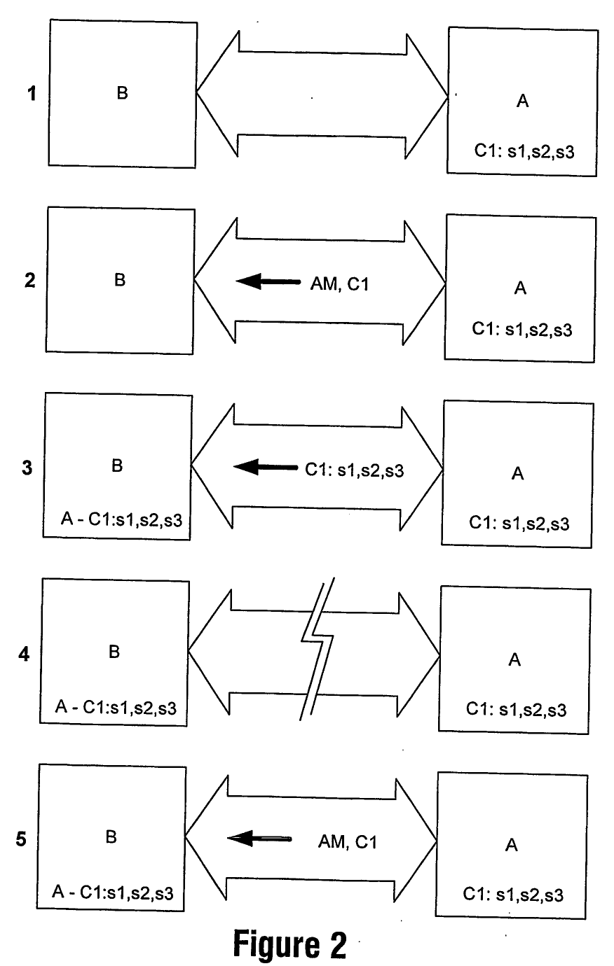

FIG. 2 is an illustration according to the present invention of the method for a first communication device of maintaining an up-to-date configuration description of a second communication device, when the network connection between the two devices is interrupted,

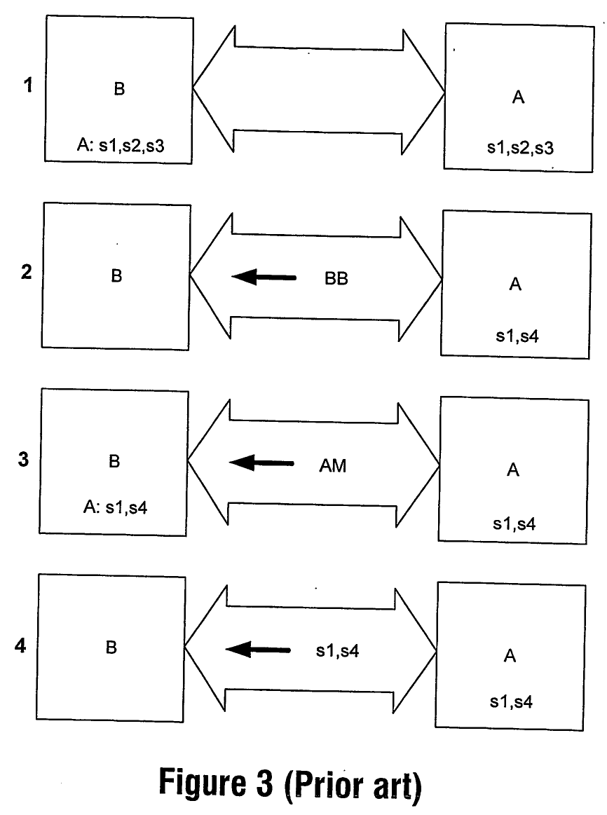

FIG. 3 is an illustration according to prior art of the method for a first communication device of maintaining an up-to-date configuration description of a second communication device, when the configuration of the second communication device changes,

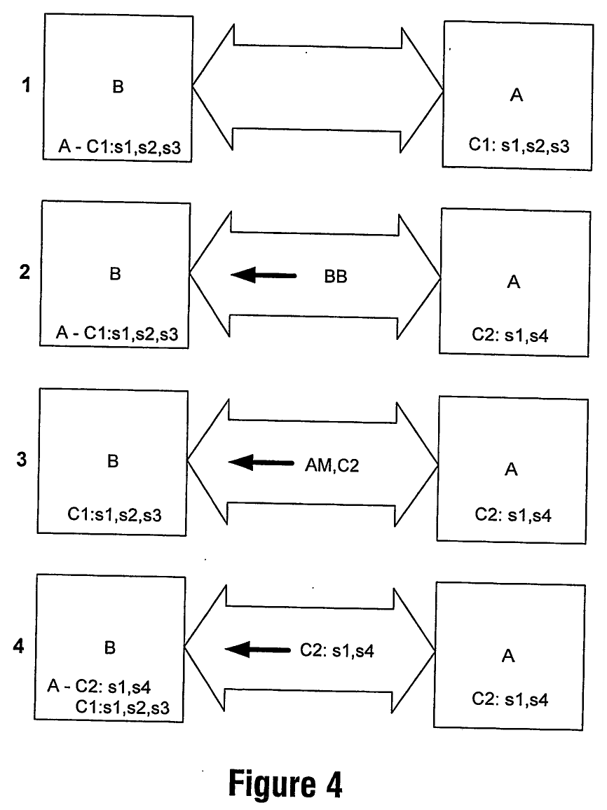

FIG. 4 is an illustration according to the present invention of the method for a first communication device of maintaining an up-to-date configuration description of a second communication device, when the configuration of the second communication device changes,

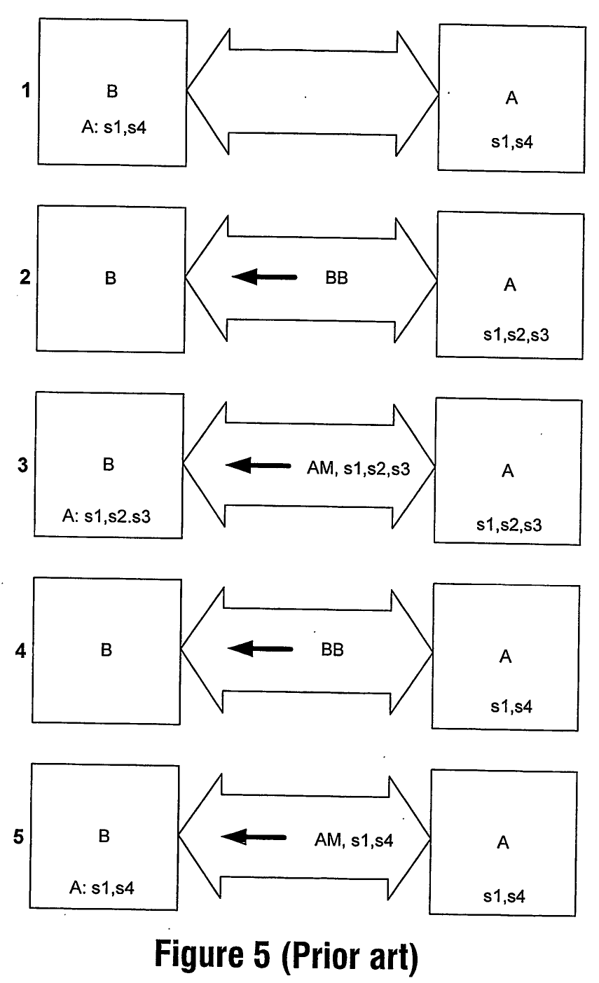

FIG. 5 is an illustration according to prior art of the method for a first communication device of maintaining an up-to-date configuration description of a second communication device, when the configuration of the second communication device changes between two presently used configurations,

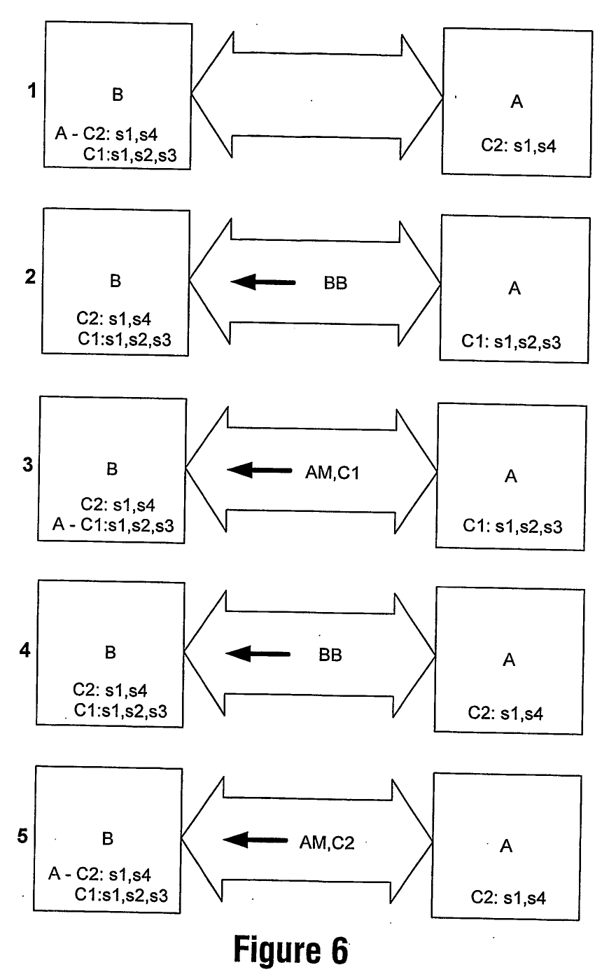

FIG. 6 is an illustration according to the present invention of the method for a first communication device of maintaining an up-to-date configuration description of a second communication device, when the configuration of the second communication device changes between two presently used configurations, and

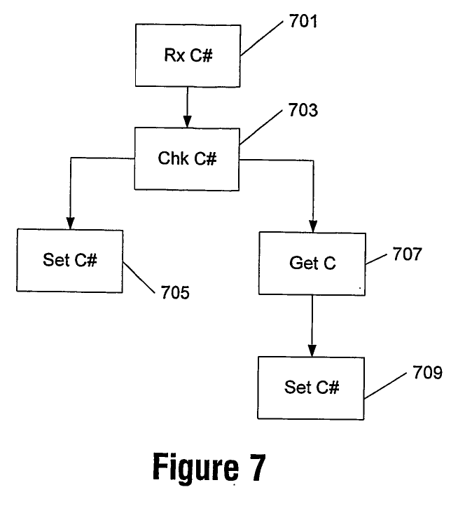

FIG. 7 illustrates a method of keeping up-to-date service descriptions according to the present invention.

FIG. 1 is an illustration according to prior art of the method for a first communication device B of maintaining an up-to-date configuration description of a second communication device A, when the network connection between the two devices is interrupted. Initially in step 1 respectively the first device B and the second device A are illustrated. In the following examples the first device B is referred to as an UPnP control point, and the second device A is referred to as UPnP controlled device. Both A and B are placed for communication in a UPnP network. The second device A has a configuration and in this example the configuration comprises providing a service with features s1, s2 and s3. In step 1 the two devices are still not aware of each other. In step 2 device A sends one or more announcement messages AM to device B, device B receives these announcement messages, and by checking its cache memory, it realizes that it does not have the configuration description of device A. In step 3 the device B downloads the configuration description of device A and stores the configuration description in its cache as the active configuration description of device A. As long as the UPnP device A does not change its configuration, device B has knowledge of the configuration of A. In step 4 the network connection between A and B is interrupted, e.g. because of a network hiccup, and the cache of device B is timed out, whereby the cache information related to A is deleted. In step 5 the network connection is restored, and because the cache is timed out, step 3 has to be repeated. Device B downloads the configuration description of device A and stores the configuration description in its cache as the active configuration description of device A.

FIG. 2 is an illustration according to the present invention displaying the situation from FIG. 1, but according to the present invention. In step 1 the two devices are still not aware of each other. Device A has a configuration description comprising providing a service with features s1, s2 and s3. The service description has been identified in the device A with a configuration identifier being C1. In step 2 device A sends one or more announcement messages AM to device B. Together with the announcement messages it sends the configuration identifier C1. The device B checks its cache memory and realizes that it does not have the configuration identified by C1. In step 3 the device B downloads the configuration description of device A and stores the configuration description and the corresponding configuration identifier in its cache and sets it as the active configuration description of device A. In step 4 the network connection between A and B is interrupted, e.g. because of a network hiccup. Since there is no time out, the cache information related to A is not deleted. However, since no communication is received from B, A sets device B to “inactive”. In step 5, corresponding to step 2, device A sends one or more announcement messages AM to device B, device B receives these announcement messages, together with the configuration identifier C1, and by checking its cache memory it realizes that it has already stored the configuration description of device A identified by the configuration identifier C1. It therefore sets the corresponding configuration description as the active configuration description of device A.

Whenever a configuration description needs to be deleted from the storage medium (to avoid running out of memory), the configuration description that has not been accessed for the longest time interval of all present configuration descriptions could be deleted from the storage medium. Thereby a limited sized storage medium can be used decreasing the chance of running out of memory. In general, other caching techniques could be applied.

FIG. 3 is an illustration according to prior art of the method for a first communication device of maintaining an up-to-date configuration description of a second communication device when the configuration of the second communication device changes. In step 1 the two devices are ready for mutual communication, and the configuration description stored in the cache of the control point B comprises that A provides a service with features s1, s2, s3, corresponding to the actual configuration of A. In step 2 device A changes configuration and sends bye-bye BB messages to B. This bye-bye BB message is received by B, which clears the configuration description of A from its cache. Next in step 3, the device A sends one or more announcement messages AM to device B, device B receives these announcement messages, and by checking its cache memory it realizes that it does not have the configuration description of device A. In step 4 the device B downloads the configuration description of device A and stores the configuration description in its cache as the active configuration description of device A. As long as the device A does not change its configuration, device B has again knowledge of the configuration of A.

FIG. 4 is an illustration according to the present invention of the method for a first communication device of maintaining an up-to-date configuration description of a second communication device, when the configuration of the second communication device changes. In step 1 the two devices are ready for mutual communication, and the configuration description stored in the cache of the control point B comprises a description of A being configured according to the configuration identifier C1. The description stored in B corresponds to the configuration identifier of the actual configuration of A. In step 2 device A changes configuration to one having the configuration identifier C2 and sends bye-bye BB messages to B. This bye-bye BB message is received by B, which does not clear the configuration description of A from its cache, but leaves it stored in the cache together with the configuration identifier C1, but not as an active configuration. In step 3 device A sends one or more announcement messages AM to device B. Together with the announcement messages it sends the configuration identifier C2. The device B checks its cache memory and realizes that it does not have the configuration identified by C2. In step 4 the device B downloads the configuration description of device B and stores the configuration description and the corresponding configuration identifier C2 in its cache and sets it as the active configuration description of device A.

FIG. 5 is an illustration according to prior art of the method for a first communication device of maintaining an up-to-date configuration description of a second communication device, when the configuration of the second communication device changes between two presently used configurations. In step 1 the two devices are ready for mutual communication, and the configuration description stored in the cache of the control point B comprises that A provides a service with features s1 and s4, corresponding to the actual configuration of A. In step 2 device A changes configuration and sends bye-bye BB messages to B. This bye-bye BB message is received by B, which clears the configuration description of A from its cache. Next in step 3 the device A sends one or more announcement messages AM to device B. Device B receives these announcement messages, and by checking its cache memory it realizes that it does not have the configuration description of device A. Device B then downloads the configuration description of device A and stores the configuration description in its cache as the active configuration description of device A. As long as the device A does not change its configuration, device B has again knowledge of the configuration of A. In step 4 device A changes configuration back again and sends bye-bye BB messages to B. This bye-bye BB message is received by B, which clears the configuration description of A from its cache. Next in step 5 the device A sends one or more announcement messages AM to device B. Device B receives these announcement messages, and by checking its cache memory it realizes that it does not have the configuration description of device A. Device B then downloads the configuration description of device A and stores the configuration description in its cache as the active configuration description of device A. As long as the UPnP device B does not change its configuration, device B has again knowledge of the configuration of A.

FIG. 6 is an illustration according to the present invention of the method for a first communication device of maintaining an up-to-date configuration description of a second communication device, when the configuration of the second communication device changes between two presently used configurations. In step 1 the two devices are ready for mutual communication, and configuration description stored in the cache of the control point B comprises a description of that A is configured according to the configuration identifier C2. It further comprises a configuration description identified by configuration identifier C1. In step 2 device A changes configuration to one having the configuration identifier C1 and sends bye-bye BB messages to B. This bye-bye BB message is received by B, which does not clear the configuration description of A from its cache but lets it remain stored in the cache together with the configuration identifier C2, but not as an active configuration. In step 3 device A sends one or more announcement messages AM to device B. Together with the announcement messages it sends the configuration identifier C1. The device B checks its cache memory and realizes that it does have the configuration identified by C1 and sets the corresponding configuration description as the active configuration of device A. In step 4 device A changes configuration back to the one having the configuration identifier C2 and sends bye-bye BB messages to B. This bye-bye BB message is received by B, which does not clear the configuration description of A from its cache but lets it remain stored in the cache together with the configuration identifier C2, but not as an active configuration. In step 5 device A sends one or more announcement messages AM to device B. Together with the announcement messages it sends the configuration identifier C2. The device B checks its cache memory and realizes that it does have the configuration identified by C2 and sets the corresponding configuration description as the active configuration of device A.

In FIG. 7 the method is illustrated to be used by an apparatus for handling configuration numbers for keeping up-to-date service descriptions of controlled devices. The apparatus could e.g. be a control point in an UPnP network. Initially in the step 701 the apparatus receives the configuration identifier C# from an UPnP device. This could be received together with all messages from the UPnP device in order to ensure that the configuration description used in the control point is always up-to-date. In step 703 the apparatus checks its cache memory to see if it has already stored a configuration description having this configuration identifier. In step 705 a corresponding configuration identifier has been found in the cache memory of the control point, and the control point sets the corresponding configuration description as the present configuration of the UPnP device. In 707 the configuration identifier is not found in the cache memory and the control point downloads the configuration description of the UPnP device and stores the configuration description and the corresponding configuration identifier in its cache. Finally, in 709 the control point sets the downloaded configuration description of device A as active.

It is noted that the above may be implemented as general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

It should be further noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for a first communication device (B) of maintaining an up-to-date configuration description of a second communication device (A), said first device (A) comprises a storage medium and is adapted for storing on said storage medium configuration descriptions being uniquely identified by a configuration identifier (C#), the method comprises the steps of:
receiving (701) from the second device A information comprising a configuration identifier (C#) uniquely identifying the configuration of the second device (A),
checking (703) whether the configuration description identified by the received configuration identifier (C#) is already stored on the storage medium,
if said configuration description is already stored on the storage medium, setting (705) the configuration description corresponding to the received configuration identifier (C#) as the active configuration description of the second device (A),
if said configuration description identified by the configuration identifier (C#) is not stored on the storage medium, requesting and receiving (707) the configuration description from said second device (A), storing said configuration description together with said configuration identifier (C#) on said storage medium and setting (709) the configuration corresponding to the received configuration identifier (C#) as the active configuration description of the second device (A).

2. A method according to claim 1, wherein the unique configuration identifier (C#) comprises an identification of the second device (A).

3. A method according to claim 1, wherein the configuration description comprises an identification of the services offered by the second device (A).

4. A method according to claim 1, wherein the configuration identifier (C#) is a device specific configuration number uniquely identifying the configuration of the device.

5. A method according to claim 1, wherein the configuration descriptions on the storage medium, which have not been accessed for the longest time period, are deleted from the storage medium.

6. A method according to claim 1, wherein the second device generates the configuration identifier (C#) by deriving it from the configuration description using fingerprinting.

7. A method according to claim 1, wherein the first device (B) is a control point in an UPnP network, and the second device (A) is an UPnP device being part of the UPnP network.

8. An apparatus for maintaining an up-to-date configuration description of a second communication device, said apparatus comprises a storage medium and is adapted for storing on said storage medium configuration descriptions being uniquely identified by a configuration identifier, the apparatus comprises:
means for receiving from the second device information comprising a configuration identifier uniquely identifying the configuration of the second device,
means for checking whether the configuration description identified by the received configuration identifier is already stored on the storage medium,
means for, if said configuration description identified by the configuration identifier is stored on the storage medium, setting the configuration description corresponding to the received configuration identifier as the active configuration description of the second device,
means for, if said configuration description identified by the configuration identifier is not stored on the storage medium, requesting and receiving the configuration description from said second device, storing said configuration description together with said configuration identifier on said storage medium and setting the configuration corresponding to the received configuration identifier as the active configuration description of the second device.

9. An UPnP control point for maintaining an up-to-date configuration description of a UPnP device, said control point comprises a storage medium and is adapted for storing on said storage medium configuration descriptions being uniquely identified by a configuration identifier, the control point comprises:
means for receiving from the second device information comprising a configuration identifier uniquely identifying the configuration of the UPnP device,
means for checking whether the configuration description identified by the received configuration identifier is already stored on the storage medium,
means for, if said configuration description identified by the configuration identifier is stored on the storage medium, setting the configuration description corresponding to the received configuration identifier as the active configuration description of the UPnP device,
means for, if said configuration description identified by the configuration identifier is not stored on the storage medium, requesting and receiving the configuration description from said UPnP device, storing said configuration description together with said configuration identifier on said storage medium and setting the configuration corresponding to the received configuration identifier as the active configuration description of the UPnP device.
